(19) United States
(12) Patent Application Publication
(10) Pub. No.: US 2011/0011712 A1
(43) Pub. Date: Jan. 20, 2011

(54) ADJUSTABLE INPUT DEVICE

(75) Inventor: Gunnar Klinghult, Lund (SE)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/504,858

(22) Filed: Jul. 17, 2009

(51) Int. Cl. H01H 3/00

(52) U.S. Cl. 200/341

(57) ABSTRACT

A device may include a housing, a button and a member coupled to the button. The device may also include a power source configured to supply power to the member. When power is supplied to the member, the member is configured to exert a force on the button to cause movement of the button such that an upper surface of the button protrudes above an upper surface of the housing.

### TECHNICAL FIELD OF THE INVENTION

The invention relates generally to input devices and, more particularly, to adjustable input devices.

### DESCRIPTION OF RELATED ART

Communication devices, such as cellular telephones, have become increasingly versatile. For example, cellular telephones often include music players, cameras, etc., that enable the telephones to perform functions formerly performed by other devices, such as stand-alone music players, stand-alone cameras, etc.

In a typical communication device, raised buttons on the surface of the device are used to initiate various functions, such as music playing functions, activate a camera mode, etc. One drawback with raised buttons is that such raised buttons are often inadvertently pressed while the communication device is in a user's pocket or while the user is performing some function. For example, a user may inadvertently press a camera mode button that activates the camera when the user picks up the communication device to place a call. In addition, buttons that project out from the body of the communication device are often damaged over time. Such damage may eventually affect the ability of the buttons to perform their intended functions.

### SUMMARY

According to one aspect, a device may be provided. The device includes a housing, a button and at least one member coupled to the button. The device may also include a power source configured to supply power to the at least one member, wherein when power is supplied to the at least one member, the at least one member is configured to exert a force on the button to cause movement of the button such that an upper surface of the button protrudes above an upper surface of the housing.

Additionally, the at least one member may comprise a first member, the first member being configured to contract when power is supplied to the first member. The contraction of the first member may cause movement of the button in an upward direction with respect to the housing.

Additionally, the at least one member may comprise a first member configured to have a first shape when the first member is above a threshold temperature and a second shape when the first member is not above the threshold temperature. The at least one member may also comprise a second member configured to have the second shape when the second member is above the threshold temperature and the first shape when the second member is not above the threshold temperature, wherein the power source selectively applies power to the first and second members to heat the first and second members based on an operating mode of the device.

Additionally, the device may further comprise an isolating layer formed between the first and second members, the isolating layer providing at least one of electrical or heat isolation between the first and second members.

Additionally, the device may further comprise a dome-shaped structure disposed between the first member and a lower surface of the button, wherein when the first member is heated above the threshold temperature, the first member exerts an upward force on the dome-shaped structure, the upward force causing a portion of the button to move above the upper surface of the housing.

Additionally, the device may further comprise logic configured to control the power source to selectively supply power to the at least one member to move the button in an upward or downward direction with respect to the upper surface of the housing based on an application mode associated with the device.

Additionally, the at least one member may comprise a first member and a second member, and wherein the logic may be further configured to control the power source to supply power to the first member when an application associated with the button is activated, and control the power source to supply power to the second member when the application associated with the button is de-activated.

Additionally, the at least one member may comprise an alloy that contracts when the alloy is heated to a predetermined temperature.

Additionally, the alloy may comprise nickel and titanium.

Additionally, the device may comprise a mobile terminal.

According to another aspect, a method performed by a mobile device is provided. The method includes receiving a first selection associated with a first operating mode of the mobile device, providing power to a first member upon receiving the first selection and raising a button or input device above an upper surface of the mobile device in response to the first selection.

Additionally, the first member may be configured to contract when the first member is heated to a predetermined temperature, and the raising a button or input device may comprise providing an upward force on the button in response to the contraction of the first member.

Additionally, the method may comprise receiving a second selection to deactivate the first operating mode, providing power to a second member coupled to the first member upon receiving the second selection, and lowering the button or input device to a level at or below the upper surface of the mobile device in response to the second selection.

According to a further aspect, a device comprising logic configured to identify an operating mode of the device, a button, a button adjustor and a power source is provided. The button adjustor is configured to adjust a height of the button with respect to a housing of the device based on the operating mode of the device and the power source is configured to supply power to the button adjustor under control of the logic. When power is supplied to the button adjustor, the button adjustor is configured to exert a force on the button to move the button with respect to the housing of the device.

Additionally, the button may be associated with performing a camera-related function or a music-related function.

Additionally, the button adjustor may comprise a first member and a second member. The first member may be configured to have a first shape when the first member is above a threshold temperature and a second shape when the first member is not above the threshold temperature. The second member may be configured to have the second shape when the second member is above the threshold temperature and the first shape when the second member is not above the threshold temperature, wherein the power source selectively applies power to the first and second members to heat the first and second members to above the threshold temperature based on the operating mode of the device.

Additionally, the button adjustor may further comprise an isolating layer formed between the first and second members, the isolating layer providing at least one of electrical or heat isolation between the first and second members.

Additionally, the button adjustor may further comprise a structure disposed between the first member and a lower surface of the button, the structure being configured to apply a force associated with contraction of the first member to the button to move the button in a direction perpendicular to a surface of the housing.

Additionally, the power source may be configured to supply a pulse for a duration of less than one second to the button adjustor.

Other features and advantages of the invention will become readily apparent to those skilled in this art from the following detailed description. The embodiments shown and described provide illustration of the best mode contemplated for carrying out the invention. The invention is capable of modifications in various obvious respects, all without departing from the invention. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a diagram of an exemplary user device in which methods and systems consistent with the invention may be implemented;

FIG. 2 is a functional block diagram of exemplary components implemented in the device of FIG. 1;

FIGS. 3A-3C are diagrams of an actuator mechanism used to adjust an input button according to an exemplary implementation;

FIGS. 4A and 4B are diagrams of a portion of the user device of FIG. 1 according to an exemplary implementation;

FIG. 5 is a flow diagram illustrating exemplary processing associated with adjusting the height of an input button; and

FIGS. 6A-6C are diagrams of an actuator mechanism used to adjust an input button according to another exemplary implementation.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

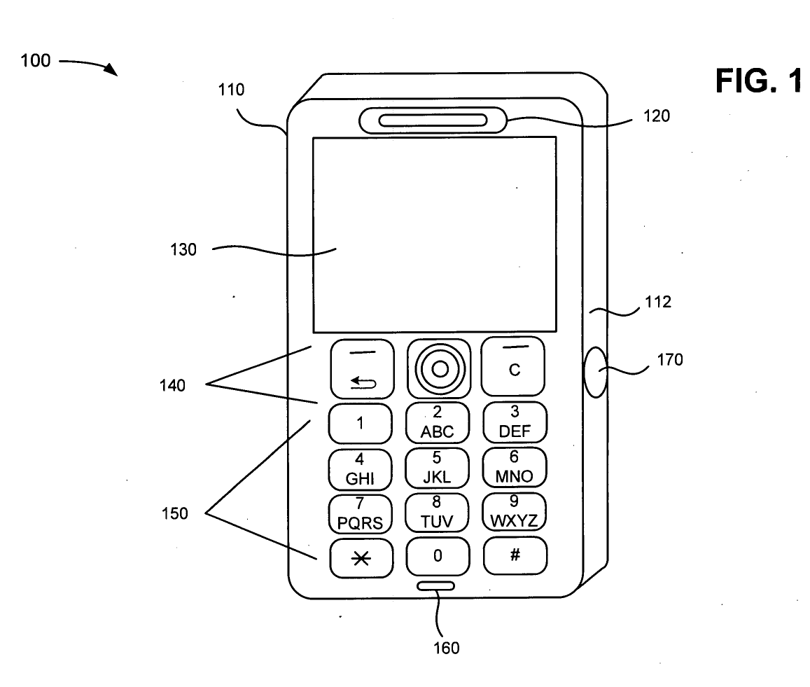

FIG. 1 is a diagram of an exemplary user device 100 in which methods and systems described herein may be implemented. In an exemplary implementation, user device 100 may be a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

It should be understood that systems and methods described herein may also be implemented in other devices that use input buttons to allow users to provide information or perform functions with or without including various other communication functionality. For example, user device 100 may include a personal computer (PC), a laptop computer, a personal digital assistant (PDA), a media playing device (e.g., an MPEG audio layer 3 (MP3) player, a video game playing device), a camera, a GPS device, etc., that may not include various communication functionality for communicating with other devices.

Referring to FIG. 1, user device 100 may include a housing 110, a speaker 120, a display 130, control buttons 140, a keypad 150, a microphone 160 and a button 170. Housing 110 may protect the components of user device 100 from outside elements. Speaker 120 may provide audible information to a user of user device 100.

Display 130 may provide visual information to the user. For example, display 130 may provide information regarding incoming or outgoing telephone calls, electronic mail (e-mail), instant messages, short message service (SMS) messages, etc. Display 130 may also display information regarding various applications or a menu for launching various applications/modes, such as a music playing application, a camera mode, a video game application, etc. Display 130 may further act as a view finder when user device 100 is operating in a camera mode. In some implementations, display 130 may be a touch screen display device that allows a user to enter commands and/or information via a finger, a stylus, a mouse, a pointing device, or some other device. For example, display 130 may be a resistive touch screen, a capacitive touch screen, an optical touch screen, an infrared touch screen, a surface acoustic wave touch screen, or any other type of touch screen device that registers an input based on a contact with the screen/display 130.

Control buttons 140 may permit the user to interact with user device 100 to cause user device 100 to perform one or more operations, such as place a telephone call, play various media, etc. In an exemplary implementation, control buttons 140 may include one or more buttons that controls various applications. For example, one or more of control buttons 140 may be used to initiate execution of an application program that results in the raising or lowering of button, such as button 170, above/below the upper surface 112 of housing 110, as described in detail below. Control buttons 140 may also include a menu button that permits the user to view a menu associated with launching an application or performing a function, such as a camera application/function.

Keypad 150 may include a standard telephone keypad. Microphone 160 may receive audible information from the user. In some instances, the audible information may be used to activate one or more applications or routines stored in user device 100.

Button 170 may be an input device used to initiate an action or function on user device 100. For example, button 170 may be associated with a camera mode of user device 100. In such implementations, button 170 may be a shutter button used to take a picture, a zoom button used to zoom in/out prior to taking a picture, an auto-focus button, etc. Alternatively, button 170 may be an input device associated with interacting with or initiating a music playing application, a game playing application, etc. In such implementations, button 170 may be a play button, a re-wind button, a pause button, a button associated with an acoustic port of user device 100, etc.

In an exemplary implementation, button 170 may be slightly recessed or countersunk with respect to surface 112 of housing 110 when button 170 is not active or an application associated with button 170 is not active. For example, if button 170 is a shutter button associated with taking pictures, button 170 may be slightly recessed with respect to surface 112 when user device 100 is not in the camera mode. When the camera mode is activated, the upper surface of button 170 may be raised to a level above surface 112, as described in detail below.

The configuration illustrated in FIG. 1 is provided for simplicity. One skilled in the art would recognize that user device 100 may be configured in a number of other ways and may include other or different elements. For example, in some implementations, user device 100 may include multiple buttons similar to button 170 that are located on various locations of housing 110.

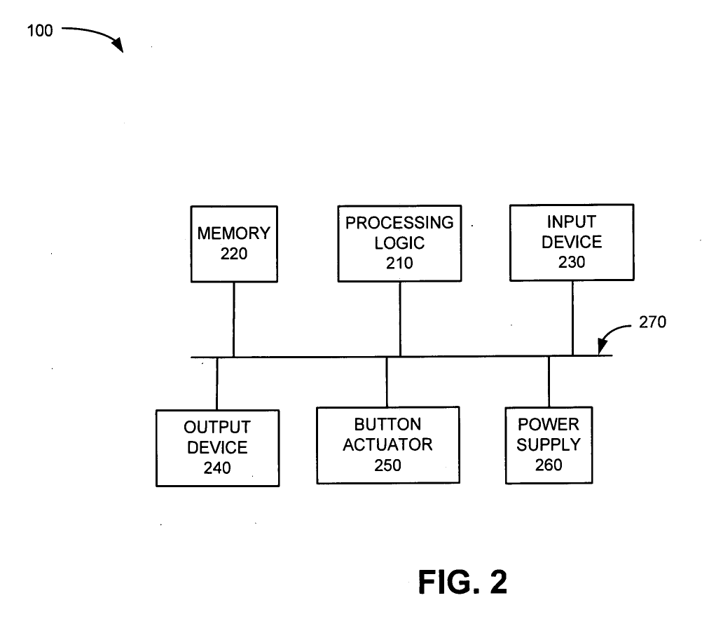

FIG. 2 is a diagram of user device 100 according to an exemplary implementation. Referring to FIG. 2, user device 100 may include processing logic 210, memory 220, input device 230, output device 240, button actuator 250 and power supply 260. Bus 270 may interconnect all or some of the components of user device 100. One skilled in the art would recognize that user device 100 may be configured in a number of other ways and may include other or different elements, such as communication-related elements (e.g., one or more radio frequency (RF) antennas, a transceiver, modulator/demodulator, encoder/decoder, etc.).

Processing logic 210 may include a processor, microprocessor, an application specific integrated circuit (ASIC), field programmable gate array (FPGA) or the like. Processing logic 210 may execute software programs or data structures to control operation of user device 100. Memory 220 may include a random access memory (RAM) or another type of dynamic storage device that stores information and instructions for execution by processing logic 210; a read only memory (ROM) or another type of static storage device that stores static information and instructions for use by processing logic 210; and/or some other type of magnetic or optical recording medium and its corresponding drive. Instructions used by processing logic 210 may also, or alternatively, be stored in another type of computer-readable medium accessible by processing logic 210. A computer-readable medium may include one or more memory devices.

Input device 230 may include any mechanism that permits a user to input information to user device 100, such as button 170, microphone 160, keyboard 150, control buttons 140, display 130 (e.g., a touch screen display), a mouse, a pen, voice recognition and/or biometric mechanisms, etc. In an exemplary implementation, a user may provide an input via keyboard 150, control buttons 140 or display 130 and view a menu of options via display 130. The menu may allow the user to select a particular mode associated with user device 100, such as a camera mode, a music playing mode, etc. Alternatively, input device 230 may include particular buttons, input keys, etc., that allow the user to activate a particular mode for user device 100. Input device 230 may also include button 170 that may be adjusted based on the operating mode of user device 100, as described in detail below.

Output device 240 may include one or more mechanisms that output information to the user, including a display, such as display 130, a printer, one or more speakers, such as speaker 120, etc. As described above, in some implementations, display 130 may be a touch screen display. In such an implementation, display 130 may function as both an input device and an output device.

Button actuator 250 (also referred to herein as actuator 250) may include one or more components or structures that can be used to perform one or more functions associated with operation of user device 100. For example, in one implementation, actuator 250 may be used to raise/lower button 170 with respect to surface 112 of housing 110 (FIG. 1), as described in detail below.

Power supply 260 may include one or more batteries and/or other power source components used to provide power to user device 100. In one implementation, power supply 260 may also include circuitry and/or components used to selectively provide power to actuator 250 based on the mode in which user device 100 is operating

User device 100, consistent with the invention, may perform processing associated with, for example, raising and lower a button, such as button 170. User device 100 may perform these operations in response to processing logic 210 and/or another device in user device 100 (e.g., a camera) executing sequences of instructions contained in a computer-readable medium, such as memory 220. Execution of sequences of instructions contained in memory 220 may cause processing logic 210 and/or another device in user device 100 to perform acts that will be described hereafter. In alternative embodiments, hard-wired circuitry may be used in place of or in combination with software instructions to implement processes consistent with the invention. Thus, implementations consistent with the invention are not limited to any specific combination of hardware circuitry and software.

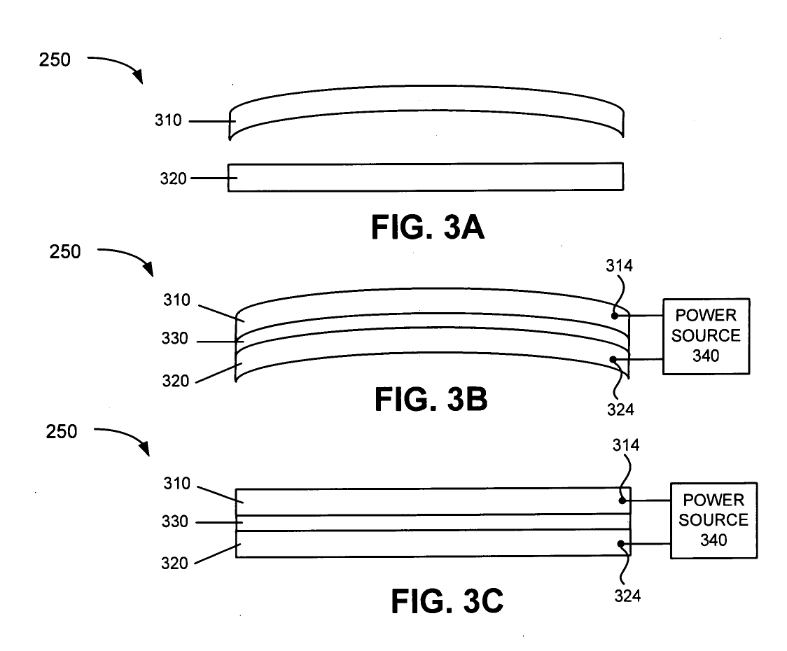

FIG. 3A is a diagram of components of actuator 250 in an exemplary implementation. Referring to FIG. 3A, actuator 250 may include members 310 and 320. Members 310 and 320 may include terminals (not shown in FIG. 3A) that are configured to receive power from a power source (also not shown in FIG. 3A). When power is applied to member 310 and/or 320, the member 310/320 may change its shape and/or size. For example, members 310 and 320 may be fabricated from material that changes shape or size when the material is heated beyond a particular temperature. The particular temperature needed to change the shape/size depends on the particular material. In one implementation, members 310 and 320 may be made of an alloy that is designed to contract (i.e., member 310/320's length becomes shorter) when member 310/320 is heated beyond a threshold temperature. In addition, the alloy may be fabricated to have poor conductivity (e.g., have resistive characteristics). In this manner, when power is applied to member 310/320, the member 310/320 becomes quickly heated beyond the threshold temperature, thereby causing member 310/320 to contract or deform.

In an exemplary implementation, members 310 and 320 may include alloys made from nickel and titanium that are known as “muscle wires” or “memory alloys”. For example, members 310 and 320 may be fabricated using Nitinol, Flexinol or similar materials.

In one exemplary implementation, members 310 and 320 may contract about 3% to 5% when heated beyond a threshold temperature. In one exemplary implementation, the threshold temperature may range from about 88 to 98 degrees Celsius. Members 310 and 320 may also relax (e.g., return to the pre-heated state) at a temperature ranging from about 62 degrees to 72 degrees Celsius.

In an exemplary implementation, member 310 may be fabricated such that its relaxed (i.e., pre-heated) state has a curved or convex cross-sectional shape, as illustrated in FIG. 3A. In other words, the upper surface of member 310 may bow out in its middle section when member 310 is in its normal, relaxed state. In addition, member 320 may be fabricated such that its relaxed state has a substantially rectangular cross-sectional shape, as illustrated in FIG. 3A. This may allow members 310 and 320 to be deformed into desired shapes/sizes that may be used to selectively exert forces on button 170, as described in detail below.

For example, FIG. 3B illustrates actuator 250 that includes members 310 and 320, and layer 330 disposed between members 310 and 320. Members 310 and 320 may also include terminals 314 and 324, respectively, coupled to power source 340. In some implementations, power source 340 may correspond to power supply 260. In other implementations, power source 340 may correspond to processing logic 210 and/or output device 240. For example, processing logic 210 or output device 240 may include one or more general purpose input/output (GPIO) ports that provide power to members 310 and 320.

Layer 330 may include a material that provides electrical and/or heat isolation between member 310 and 320. In an exemplary implementation, layer 330 may include kapton, teflon or any other material that provides heat and/or electrical isolation between members 310 and 320. Providing electrical and heat isolation between members 310 and 320 ensures that the temperatures of members 310 and 320 may be independently controlled. This enables user device 100 to selectively control the relaxed/contracted states of members 310 and 320.

In FIG. 3B, layers 310-330 may be mounted together or bonded/connected together such that member 310 is in its relaxed state (i.e., curved) and member 320 is deformed to have a curved cross-sectional shape. That is, member 320 is mounted such that it is deformed to the curved shape illustrated in FIG. 3B. When power is supplied to member 320 (i.e., the member having the rectangular cross-sectional shape when in the relaxed state) via power source 340, the power may heat member 320 above its relaxed temperature threshold (e.g., above 88 degrees Celsius) such that member 320 contracts and returns to its original relaxed state. FIG. 3C illustrates the resulting shapes of members 320 and 320. Since members 310 and 330 are mounted or bonded together with member 320, when member 320 reverts to its relaxed state, member 310 will be deformed to have the rectangular cross-sectional shape illustrated in FIG. 3C. This condition of actuator 250 may correspond to the lowering of button 170 to a level at or slightly below surface 112 of housing 110, as described in detail below.

When members 310 and 320 are in the shapes illustrated in FIG. 3C, power may be provided to member 310 (i.e., the member having the curved cross-sectional shape when in the relaxed state) via power source 340 and terminal 314. In this case, the power may heat member 310 above its temperature threshold (e.g., above 88 degrees Celsius) such that member 310 returns to its original, curved cross-sectional shape illustrated in FIG. 3B. This condition of actuator 250 may provide forces on button 170 to allow button 170 to be raised to a level above surface 112 of housing 110, as described in detail below.

As illustrated, members 310 and 320 may be supplied with power from power source 340 via connections at terminals 314 and 324. As described above, in some implementations, power source 340 may correspond to power supply 260, which may include circuitry for providing power to members 310 and 320 based on the operating mode associated with user device 100, such as a camera mode, music playing mode, etc. For example, power supply 260 may include a switch that is controlled (e.g., opened/closed) by, for example, processing logic 210 to provide power to members 310 and 320. In other implementations, power source 340 may represent one or more digital GPIO ports (e.g., two GPIO ports) that are associated with output device 240 or processing logic 210 that may provide power to actuator 250 based on a mode associated with operation of user device 100. For example, in one implementation, processing logic 210 may signal or drive output device 240 to output power (e.g., pulses having a particular voltage) to members 310 and 320 based on the particular operating mode of user device 100. Alternatively, processing logic 210 may drive one or more GPIO ports that output power to members 310 and 320 based on the particular operating mode of user device 100. In each case, power may be selectively provided to actuator 250 to modify the shape and/or size of members 310 and 320 to exert forces on button 170.

In an exemplary implementation, members 310 and/or 320 may exert such forces via another structure that is designed to concentrate or maximize the forces applied to button 170. For example, in one implementation, members 310 and 320 may be used to apply a predetermined force on a structure coupled to button 170. The structure may allow a relatively small contraction/deformation of members 310/320 to achieve the desired movement of button 170 above/below the surface of housing 110.

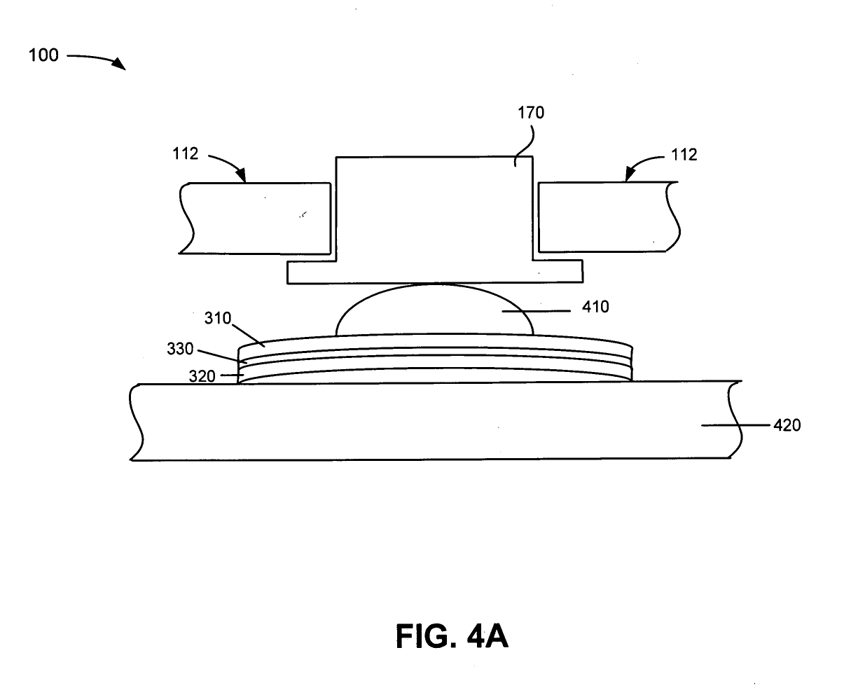

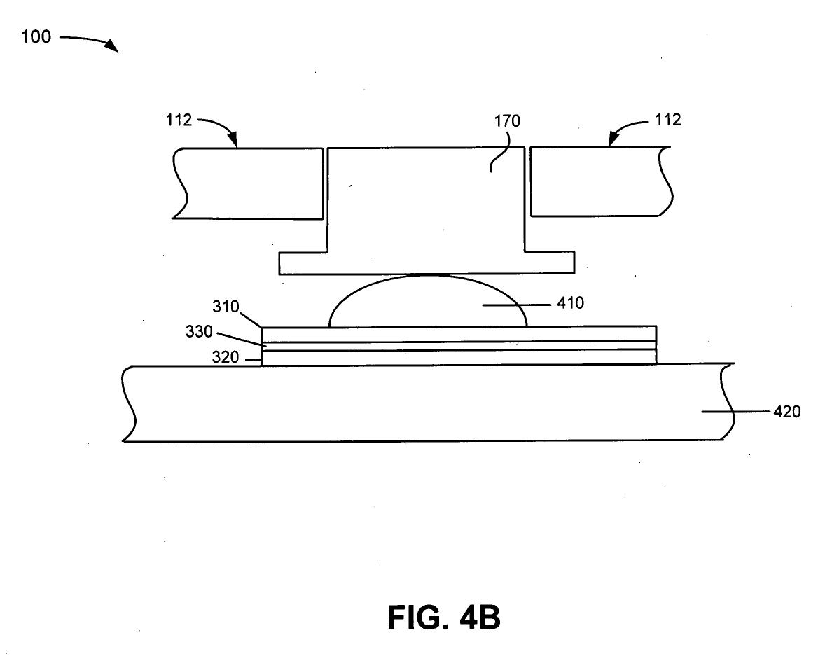

For example, FIG. 4A illustrates portions of user device 100 according to an exemplary implementation. Referring to FIG. 4A, domed structure 410 (also referred to herein as dome 410), actuator 250 (e.g., layers 310-330), support 420 and at least a portion of button 170 may each be included within user device 100 below an upper surface of housing 110. Dome 410 may be formed between member 310 and the lower surface of button 170. Member 320 may be formed over support 420. Support 420 may represent a substrate, circuit board, or other layer/structure located within housing 110 that may be used to support actuator 250, dome 410 and button 170.

Dome 410 may be made of plastic, metal or some composite material. Dome 410 may be designed to transfer and/or maximize forces supplied by member 310 to the lower surface of button 170. Dome 410 is illustrated as having a dome-like shape. It should be understood that dome 410 may have other shapes and sizes. In each case, dome 410 may contact the upper surface of member 310 and transfer forces associated with the contraction of member 310 or 320 to the lower surface of button 170.

For example, as described above with respect to FIGS. 3B and 3C, when power from power source 340 (not shown in FIG. 4A for simplicity) is supplied to member 310, member 310 becomes heated beyond the threshold temperature. Member 310 may then contract to the curved shape illustrated in FIG. 4A, resulting in layers 320 and 330 also taking the curved shape since layer 330 and member 320 are coupled to member 310. When member 310 contracts to form the curved shape, the contraction or movement of member 310 causes the middle portion of member 310 to bow out and exert an upward force on dome 410. The upward force on dome 410 in turn exerts an upward force on button 170 to push the upper surface of button 170 to the position illustrated in FIG. 4A. In this position, the upper surface of button 170 protrudes above the upper surfaces 112 of housing 110. This position of button 170 may correspond to a user of user device 100 activating a mode associated with use of button 170. For example, button 170 may be a shutter button used to take pictures while user device 100 is in a camera mode. When the camera mode of user device 100 is activated, button 170 may be raised to the position illustrated in FIG. 4A.

When power is applied to member 320, member 320 may revert to its substantially rectangular relaxed state, as illustrated in FIG. 4B. The contraction force associated with member 320 may cause member 310 and layer 320 to form the flat shape illustrated in FIG. 4B. In this state, the upward force on button 170 may be removed. Button 170 may then descend or drop to a position even with or slightly below the upper surface 112 of housing 110. That is, button 170 may move in the downward direction. Actuator 250 may be used in this manner to provide a variable height button, whose height may change depending on the operational mode of user device 100, as described in detail below.

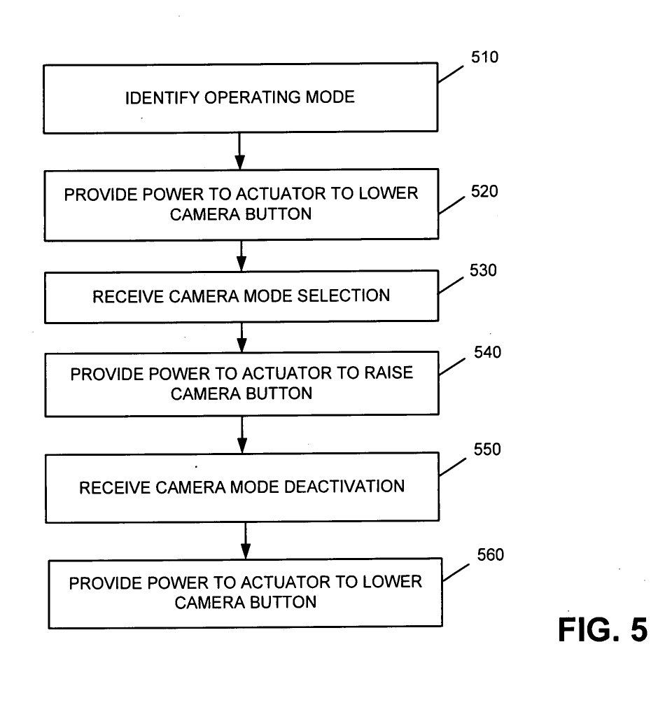

FIG. 5 is a flow diagram illustrating exemplary processing associated with adjusting the height of button of user device 100. For this example, assume that user device 100 is powered up and that button 170 is a shutter button associated with taking pictures. In one implementation, after user device 100 powers up, user device 100 may provide a default setting in which user device 100 is configured to operate in a telephone mode. Processing logic 210 may identify the operating mode (act 510). In the default telephone mode, user device 100 may power actuator 250 such that the upper surface of button 170 is at or slightly recessed with respect to surface 112 of housing 110 (e.g., in the position illustrated in FIG. 4B) (act 520).

For example, processing logic 210, output device 240 and/or power supply 260 may provide power to member 320. In one implementation, processing logic 210 may signal output device 240 to provide power to member 320. In such an implementation, output device 240 may output a pulse having a voltage ranging from, for example, one to five volts (e.g., two volts) for a duration of less than one second (e.g., 0.5 seconds or less) to member 320 via terminal 324. In other implementations, processing logic 210 may signal power supply 260 to provide the voltage pulse to member 320 or close/open an electronic switch coupled to power supply 260 to provide the pulse for the predetermined duration. In still other implementations, processing logic 210 may output the predetermined voltage pulse via GPIO port(s) associated with processing logic 210.

In each case, the power supplied to member 320 may quickly heat member 320 above the threshold temperature, such that member 320 contracts to its relaxed state illustrated in FIG. 4B. For example, in one implementation, applying power to member 320 may heat member 320 above the threshold temperature in a time period ranging from a few milliseconds (ms) to about 30 ms. Button 170 may in turn be lowered to a level at or below surface 112. In one implementation, the upper surface of button 170 may be recessed or countersunk below surface 112. For example, the upper surface of button 170 may range from approximately 0.1 millimeters (mm) to about 2 mm (e.g., about 0.8 mm) below surface 112. Countersinking button 170 below surface 112 may help avoid a user inadvertently pressing button 170.

Now assume that the user would like to begin taking pictures with user device 100. For example, the user may initiate the camera mode via, for example, input device 230 (FIG. 2). For example, the user may press a menu button via one or more of control keys 140 or keypad 150 (FIG. 1) to receive a menu of options. One of the options may be associated with activating the camera mode. Alternatively, input device 230 may include a camera activation button included in control keys 140 or elsewhere that allows a user to select/activate a camera mode. In either case, assume that the user selects the camera mode. Processing logic 210 may receive the camera mode selection (act 530).

After receiving the camera mode selection, processing logic 210 may determine that the camera mode has been selected and activate the camera functionality (e.g., the lens, viewfinder, etc.). User device 100 may also control power source 340 to supply power to actuator 250 to raise button 170 (act 540).

For example, upon receiving the camera mode selection, processing logic 210, output logic 240 and/or power supply 260 may output a pulse of voltage for a predetermined duration to terminal 314. In one implementation, processing logic 210 may signal output device 240 to provide a pulse having a predetermined voltage and duration to member 310. In such an implementation, output device 240 may output a pulse having a voltage ranging from, for example, one to five volts (e.g., two volts) for a duration of less than one second (e.g., 0.5 seconds or less) to member 310 via terminal 314. In other implementations, processing logic 210 may signal power supply 260 to provide the voltage pulse to member 310 or close/open an electronic switch coupled to power supply 260 to provide the pulse for the predetermined duration. In still other implementations, processing logic 210 may output the predetermined voltage pulse to member 310 via GPIO port associated with processing logic 210.

Member 310 may be quickly heated (e.g., in a period of time ranging from a few ms to about 30 ms) beyond the threshold temperature and contract back to its curved state, as illustrated in FIG. 4A. When member 310 contracts, member 310 may exert a force on dome 410, which in turn exerts a force on button 170 to move button 170 in an upward direction (e.g., perpendicular to surface 112 of housing 110). In an exemplary implementation, button 170 may move a predetermined distance such that the upper surface of button 170 protrudes above surface 112 of housing 110. For example, in one implementation, button 170 may move a relatively small distance, such as between 0.5 mm and 2 mm (e.g., 0.8 mm). In each case, the upper surface of button 170 protrudes above surface 112 and may be easily visible to the user. In this manner, upon selection of the camera mode, power is supplied to actuator 250 to move button 170 to a position accessible to the user to allow the user to take pictures using the camera.

Assume that the user has taken the desired number of pictures and wishes to shut down the camera mode. In this scenario, the user may select the camera function from the menu and may deactivate the camera mode. Alternatively, the user may press a camera mode button in control keys 140 or keyboard 150 to deactivate the camera mode. In either case, processing logic 210 may receive the deactivate camera mode selection (act 550).

After receiving the camera mode deactivate selection, processing logic 210, output logic 240 and/or power supply 260 may output a pulse of voltage to supply power to member 320. Member 320 may then be heated beyond the threshold and may contract. Member 320 may then exert a downward force on member 310 and button 170 may descend to the position illustrated in FIG. 4B. In this manner, actuator 250 operates as a bi-stable height adjustment mechanism to raise and lower button 170 based on the operating mode of user device 100 (e.g., whether the user wishes to operate user device 100 in the camera mode).

In some implementations, user device 100 may be configured to automatically lower button 170 upon powering down, even if the user does not deactivate the camera before powering down. In this case, power is supplied to member 320, as described above, to lower button 170. The upper surface of button 170 will then be at or below the upper surface 112 of housing 110 when button 170 is not needed.

The implementations described above refer to providing a single pulse to member 310 or member 320 to effect movement of button 170. In some implementations, multiple pulses may be provided to members 310 and 320 to ensure that the state of button 170 (e.g., its height above or below surface 112) is correct. For example, in some instances, once member 310 is heated to the threshold temperature to move button 170 above surface 112, processing logic 210 may wait a predetermined time and provide an additional pulse to ensure that member 310 stays heated to above the threshold temperature. Providing an additional pulse at predetermined intervals may ensure that member 310 does not cool to below the threshold temperate and revert to a shape in which the force on button 170 is removed. This may prevent button 170 from moving downward while the camera mode is active. Similarly, in some implementations, when the telephone mode is active, member 320 may be periodically pulsed to ensure that button 170 remains at or below surface 112 of housing 110. In each case, power is only consumed during intervals when the pulses are supplied.

Implementations described above refer to using members 310 and 320 that have pre-formed shapes (i.e., one having a curved cross-sectional shape and the other having a rectangular cross-sectional shape) that may be modified by heating members 310 and 320 to effect movement of button 170. In other implementations, members 310 and 320 may have other shapes and/or may be configured in other ways to effect movement of button 170.

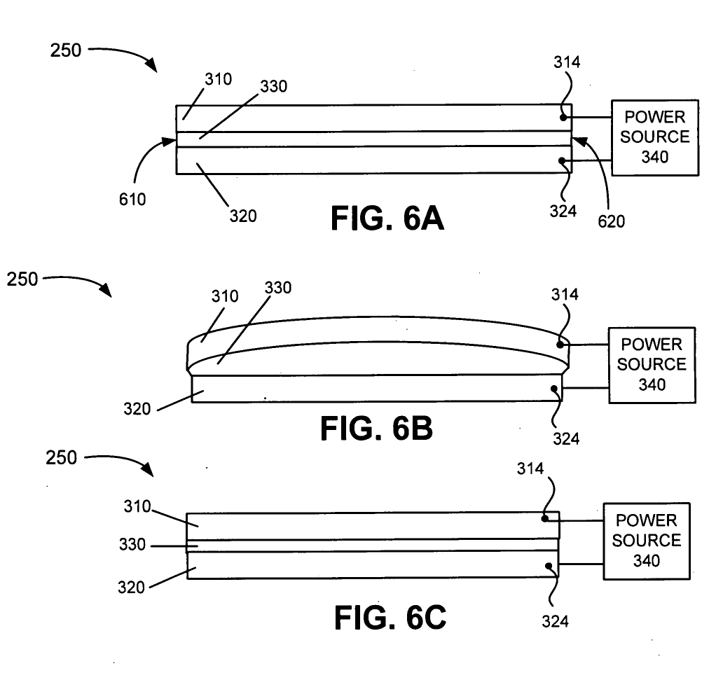

For example, in another implementation, members 310 and 320 may each be pre-formed to have a rectangular cross-sectional shape while in the relaxed (i.e., pre-heated) state, with isolating layer disposed between members 310 and 320 as illustrated in FIG. 6A. In this implementation, members 310 and 320 may be bonded together at end portions labeled 610 and 620 in FIG. 6A.

In this implementation, power may be supplied to member 320 via power source 320, resulting in member 320 contracting or shortening. FIG. 6B illustrates the resulting shapes of members 310-330 after member 320 is heated above its threshold temperature. Referring to FIG. 6B, since members 310 and 330 are bonded/connected to member 320 at locations 610 and 620, when member 320 contracts, member 310 may be pulled in an inward and downward direction, resulting in member 310 bowing outward in its middle portion. This bowing out of member 310 may exert an upward force on dome 410 and button 170 (not shown in FIG. 6B for simplicity), resulting in the raising of button 170 above surface 112 of housing 110.

When power is supplied to actuator 250 illustrated in FIG. 6B, member 310 may be heated to above its threshold temperature and contract. FIG. 6C illustrates the resulting shapes of members 310-330 after member 310 is heated above its threshold temperature. Referring to FIG. 6C, the shortening of member 310 may remove the downward and inward pulling force on member 310, thereby eliminating the force that caused member 310 to bow out. Corresponding, the upward force on dome 410 and button 170 is removed. The condition of actuator 250 illustrated in FIG. 6C may correspond to the lowering of button 170 to a level at or below surface 112 of housing 110.

It should be understood that any number of other scenarios associated with using one or more members that change shape when heated above a threshold temperature, such as members 310 and 320, may be used to effect movement of button 170. In each case, contraction of one or more members may be used to raise/lower the height of button 170 based on an operating mode of user device 100.

### Conclusion

Implementations described herein provide an adjustable button height using a structure that may have bi-stable states, resulting in a button with two discrete height positions. This may allow a designer, such as a mobile device designer, to incorporate one or more buttons that will be made available for input on an as-needed basis. Advantageously, the mechanism used to adjust the height of the button may consume little power, may operate very quickly and may operate very quietly.

The foregoing description of the embodiments of the invention provides illustration and description, but is not intended to be exhaustive or to limit the invention to the precise form disclosed. Modifications and variations are possible in light of the above teachings or may be acquired from practice of the invention.

For example, aspects of the invention have been described mainly in the context of a button used in connection with camera functionality. The button (e.g., button 170), however, may be used in connection with any particular functionality based on the particular device. In addition, buttons similar to those described above may be used in other devices, such as in stand-alone cameras, game-playing devices, GPS devices, etc., that do not also function as a cellular telephone. Still further, in some implementations, multiple buttons 170 may be provided. That is, a high density of buttons 170 may be achieved since the buttons 170 and button actuators 250 consume little space on user device 100

In addition, aspects of the invention have been described with respect to an actuator that includes two members with an isolating layer disposed between. In alternative implementations, other configurations may be used. For example, an actuator that includes a single member may be used. In this implementation, the single member may contract and provide a force to raise button 170 and when the single member cools, the button 170 may be lowered.

Still further, aspects have been described above with respect to a bi-stable state actuator. In other implementations, an actuator may provide more discrete states (e.g., height adjustment levels) using more members. In such implementations, each member may have its own unique pre-formed shape to effect movement of the button in the desired number of discrete states/increments (e.g., heights). Such actuators may be useful in instances where buttons 170 having more than two heights may be useful.

Further, while series of acts have been described with respect to FIG. 5, the order of the acts may be varied in other implementations consistent with the invention. Moreover, non-dependent acts may be performed in parallel.

It will also be apparent to one of ordinary skill in the art that aspects of the invention, as described above, may be implemented in cellular communication devices/systems, consumer electronic devices, methods, and/or computer program products. Accordingly, aspects of the present invention may be embodied in hardware and/or in software (including firmware, resident software, micro-code, etc.). Furthermore, aspects of the invention may take the form of a computer program product on a computer-usable or computer-readable storage medium having computer-usable or computer-readable program code embodied in the medium for use by or in connection with an instruction execution system. The actual software code or specialized control hardware used to implement aspects described herein are not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

The scope of the invention is defined by the claims and their equivalents.

What is claimed is:

1. A device, comprising:
a housing;
a button;
at least one member coupled to the button; and
a power source configured to supply power to the at least one member,
wherein when power is supplied to the at least one member, the at least one member is configured to exert a force on the button to cause movement of the button such that an upper surface of the button protrudes above an upper surface of the housing.

2. The device of claim 1, wherein the at least one member comprises a first member, the first member being configured to contract when power is supplied to the first member, the contraction of the first member causing movement of the button in an upward direction with respect to the housing.

3. The device of claim 1, wherein the at least one member comprises:
a first member configured to have a first shape when the first member is above a threshold temperature and a second shape when the first member is not above the threshold temperature, and
a second member configured to have the second shape when the second member is above the threshold temperature and the first shape when the second member is not above the threshold temperature, and
wherein the power source selectively applies power to the first and second members to heat the first and second members based on an operating mode of the device.

4. The device of claim 3, further comprising:
an isolating layer formed between the first and second members, the isolating layer providing at least one of electrical or heat isolation between the first and second members.

5. The device of claim 4, further comprising:
a dome-shaped structure disposed between the first member and a lower surface of the button,
wherein when the first member is heated above the threshold temperature, the first member exerts an upward force on the dome-shaped structure, the upward force causing a portion of the button to move above the upper surface of the housing.

6. The device of claim 1, further comprising:
logic configured to:
control the power source to selectively supply power to the at least one member to move the button in an upward or downward direction with respect to the upper surface of the housing based on an application mode associated with the device.

7. The device of claim 6, wherein the at least one member comprises a first member and a second member, and wherein the logic is further configured to:
control the power source to supply power to the first member when an application associated with the button is activated, and
control the power source to supply power to the second member when the application associated with the button is de-activated.

8. The device of claim 1, wherein the at least one member comprises an alloy that contracts when the alloy is heated to a predetermined temperature.

9. The device of claim 8, wherein the alloy comprises nickel and titanium.

10. The device of claim 1, wherein the device comprises a mobile terminal.

11. The device of claim 1, wherein the button is a associated with a camera function or a music playing function.

12. A method performed by a mobile device, comprising:
receiving a first selection associated with a first operating mode of the mobile device;
providing power to a first member upon receiving the first selection; and
raising a button or input device above an upper surface of the mobile device in response to the first selection.

13. The method of claim 12, wherein the first member is configured to contract when the first member is heated to a predetermined temperature, and
wherein the raising a button or input device comprises:
providing an upward force on the button in response to the contraction of the first member.

14. The method of claim 12, further comprising:
receiving a second selection to deactivate the first operating mode;
providing power to a second member coupled to the first member upon receiving the second selection; and
lowering the button or input device to a level at or below the upper surface of the mobile device in response to the second selection.

15. A device, comprising:
logic configured to identify an operating mode of the device;
a button;
a button adjustor configured to adjust a height of the button with respect to a housing of the device based on the operating mode of the device; and
a power source configured to supply power to the button adjustor under control of the logic,
wherein when power is supplied to the button adjustor, the button adjustor is configured to exert a force on the button to move the button with respect to the housing of the device.

16. The device of claim 15, wherein the button is associated with performing a camera-related function or a music-related function.

17. The device of claim 15, wherein the button adjustor comprises:
a first member configured to have a first shape when the first member is above a threshold temperature and a second shape when the first member is not above the threshold temperature, and
a second member configured to have the second shape when the second member is above the threshold temperature and the first shape when the second member is not above the threshold temperature, and
wherein the power source selectively applies power to the first and second members to heat the first and second members to above the threshold temperature based on the operating mode of the device.

18. The device of claim 17, wherein the button adjustor further comprises:
an isolating layer formed between the first and second members, the isolating layer providing at least one of electrical or heat isolation between the first and second members.

19. The device of claim 18, wherein the button adjustor further comprises:
a structure disposed between the first member and a lower surface of the button, the structure being configured to apply a force associated with contraction of the first member to the button to move the button in a direction perpendicular to a surface of the housing.

20. The device of claim 15, wherein the power source is configured to supply a pulse for a duration of less than one second to the button adjustor.
